(19) United States
(12) Patent Application Publication
(10) Pub. No.: US 2026/0202320 A1
(43) Pub. Date: Jul. 16, 2026

(54) OPTICAL INTERFEROMETRIC MEASURING DEVICE AND METHOD

(71) Applicant: PRECITEC OPTRONIK GMBH, Neu-Isenburg (DE)

(72) Inventors: Philipp Nimtsch, Gießen (DE); Simon Mieth, Frankfurt am Main (DE)

(21) Appl. No.: 19/134,152

(22) PCT Filed: Nov. 17, 2023
(86) PCT No.: PCT/EP2023/082232

§ 371 Date: May 29, 2025

(30) Foreign Application Priority Data
Nov. 30, 2022 (DE) 10 2022 131 700.5

(51) Int. Cl. G01N 21/31

(52) U.S. Cl. CPC G01N 21/31; G01N 2201/0635

(57) ABSTRACT

An optical interferometric measuring device has a light source, which generates measuring light of a continuous wavelength range, and a measuring head, which is optically connected to the light source and directs measuring light onto a measurement object and receives measuring light reflected from the measurement object. A spectrometer of the device has a fanning out the measuring light guided into the spectrometer according to wavelengths, a first detector line and a second detector line to which fanned-out measuring light is directed. A first spectrum consists output by the first detector line substantially covers the entire wavelength range at a first resolution, and a second spectrum output by the second detector line covers a section of the wavelength range at a higher resolution.

### CROSS-REFERENCE TO RELATED APPLICATIONS

This application is a U.S. national stage of International Application No. PCT/EP2023/082232 filed Nov. 17, 2023, which claims the benefit of and priority to earlier German Application No. 10 2022 131 700.5 filed Nov. 30, 2022. The entire disclosures of these earlier filed applications are hereby incorporated by reference as if fully set forth herein.

### BACKGROUND OF THE DISCLOSURE

### 1. Technical Field

The present disclosure relates to an optical interferometric measuring device with a light source, a measuring head and an optical spectrometer. The present disclosure also relates to a method for interferometric measurement.

### 2. Description of the State of the Art

In many industrial sectors, it is necessary to perform high-precision measurements of a surface topography or layer thickness for quality control purposes. For example, such measurements are required in the manufacture of wafers (box/warp/total thickness variation), offline or during the manufacturing process; in the manufacture of display glass or glass for medical applications; or for various high-precision manufacturing processes. A non-contact method that is well suited for such measurements is interferometric measurement using low coherent light.

Usually, light of a given continuous wavelength band is directed onto the measurement sample and the interference of light reflected either from two different boundary surfaces of the measurement object or from a boundary surface of the measurement object and a reference surface is caused to interfere. This interference is analyzed by means of a spectrometer resolved by wavelength and the layer thickness or optical distance to the reference surface at the measuring point is calculated from the interference-induced modulation of the spectrum, preferably using a Fourier transformation of the spectrum. The applicant sells such measuring devices under the name CHRocodile 2 IT, for example.

The spectrum of the interference light is usually detected using a photosensitive detector consisting of a large number of discrete pixels. For a given number of pixels and a given wavelength band used, each pixel therefore captures a small range of wavelengths and the captured spectrum consists of a series of discrete points.

The thicker a measured layer is, the narrower the modulation of the spectrum. There is therefore an upper limit to the layer thickness that can be resolved by the detector. In order to measure thicker layers, either the pixel density must be increased, which leads to higher costs and slower readout, or a narrower wavelength band must be used so that each pixel covers a smaller area. However, the use of a narrower wavelength band leads to the problem that not enough modulations are detected for thinner layers, which in turn means that no thin layers can be measured. The lower limit of the measuring range is defined by the bandwidth of the spectrometer and the upper limit by the smallest resolvable bandwidth (by pixel size and spot quality). This means that measuring devices have a fixed ratio between the upper and lower measuring range limits. Different measuring devices must therefore be used for different applications. For measurement objects that combine layers of very different thicknesses, there may not be a suitable measuring device that can detect them all.

### SUMMARY OF THE DISCLOSURE

It is therefore an object of the disclosure to provide an interferometric measuring device which has a larger ratio between the upper and lower measuring range limits without significantly affecting the costs and readout speed.

According to the disclosure, this object is achieved in that the optical spectrometer comprises at least one second detector line to which fanned measuring light is directed, and the second detector line consists of a plurality of detector pixels and a second spectrum consists of a series of the intensity values measured by the detector pixels of the second detector line, wherein the first spectrum covers substantially the entire wavelength range at a first resolution, and wherein the second spectrum covers a section of the wavelength range at a higher resolution.

The section of the wavelength range advantageously covers less than half of the entire wavelength range.

In an embodiment, the section of the wavelength range is roughly in the middle of the entire wavelength range. It is also advantageous if the section is selected such that it includes the wavelengths at which the emission of the light source is highest. This has the advantage of the highest possible light intensity.

Depending on the application, it is also advantageous if the section of the wavelength range is selected according to the transparency of the measurement object, in particular a range in which the measurement sample is particularly transparent. This is relevant, for example, for measurement objects made of silicon, which have a strongly varying transparency in the near-infrared range. Due to the improved transparency, thicker layers can be measured without much loss of light.

Another aspect to consider is the best achievable image or simplest implementation.

In an embodiment, the grating element comprises two partial gratings. The first partial grating directs measuring light of the entire wavelength range fanned out over the length of the first detector line and the second partial grating directs a section of the wavelength range further fanned out over the length of the second detector line. The choice of two partial gratings enables a particularly flexible design of the measuring device.

It is useful if the partial gratings form spatially separated areas of the grating element on which different parts of the measuring light beam fall. For example, a left-hand area of the grating element can form the first partial grating and a right-hand area of the grating element can form the second partial grating. Both partial gratings can be mounted on a common holder, with separate adjustment options for the angles for adjustment.

In an embodiment, the first and second partial gratings of the grating element have the same line number, but are oriented at different solid angles. Different diffraction orders of the partial gratings are used and mapped onto the respective detector line. The different diffraction orders result in a different fanning out of the wavelengths. The line number is the number of grating lines per unit length and thus determines the diffraction properties.

In an alternative embodiment, the first and second partial gratings of the grating element have different line numbers. The gratings can then be arranged at a smaller tilt relative to one another.

In an embodiment, the spectrometer has a single optical input for the measuring light. The beam is widened by collimating optics and the two partial gratings each extend partially into the beam.

In a further embodiment, the spectrometer has at least two spatially spaced optical inputs for the measuring light. In particular, light with the same properties, i.e. light which carries the same interference information, passes through each of the inputs.

In this embodiment, the grating element is may be designed as a continuous grating, and the different fanning out on the first and second detector lines is caused by the different coupling points into the spectrometer and thus different incidence on the grating element.

It is advantageous if measuring light is directed onto the detector lines in such a way that the sum of the intensity values over the first detector line and the sum of the intensity values over the second detector line are approximately equal, especially if there is no interference modulation. This ensures that the signal is approximately the same on average in all situations, so that one of the lines is not overexposed or underexposed.

In an embodiment, the measuring device comprises a reference arm. This reference arm comprises a reflective reference surface against which a path length difference is measured. The reference surface represents a fixed reference point, e.g. for a topography measurement.

Conveniently, the measuring device, or more appropriately the measuring head, can be moved relative to the object to be measured so that a topography, or local thickness distribution, can be measured. It is also possible to scan only the measuring point instead of the entire measuring head, e.g. by using scanner mirrors.

In an embodiment, all pixels of the first detector line are read out individually and the pixels of the second detector lines are read out paired or averaged in groups of N pixels. This has the effect that the different resolutions can be produced purely electronically. This option is faster than continuously reading out and processing all the pixels of the entire line. It is also possible to apply the two readout options to the same detector line at different times instead of using two separate detector lines.

According to the disclosure, a method is provided according to which a second spectrum of the result of the interference between measuring light which was reflected from a first boundary surface of the measurement object and measuring light which was reflected from at least one second boundary surface of the measurement object or from a reference boundary surface is output by the spectrometer to an evaluation device, is output to an evaluation device, wherein the second spectrum consists of a second discrete data series of intensity values over wavelengths and the number of data points per wavelength unit is greater than for the first spectrum, and wherein optical path length differences corresponding to the modulation of the spectra are calculated from both spectra by an evaluation unit.

Advantageously, the first spectrum covers a larger total wavelength range than the second spectrum, wherein in particular the total number of data points in both spectra are the same. A first intensity spectrum is therefore output over a wavelength range λ_{A}->λ_{D}, wherein the data points of the spectrum are spaced apart by Δλ₁. A second intensity spectrum over the wavelength range λ_{B}->λ_{C} is also output, wherein the data points are spaced by Δλ₂. The following applies: Δλ₁>Δλ₂ and λ_{A}≤λ_{B}≤λ_{C}≤λ_{D} and λ_{C}−λ_{B}>λ_{D}−λ_{A}.

According to an embodiment, path length differences calculated from the first spectrum and path length differences calculated from the second spectrum are consolidated and output collectively. A single list of values is output for the user, possibly together with a graphical representation of the spectra. For this purpose, the values within the overlap range in which both spectra provide evaluable results must be compared and adjusted.

With this measuring device and method, it is also possible to measure thick samples with a thin layer applied at the same time. In this case, the thin layer should be read from the small measuring range and the total thickness from the large measuring range. Externally, the device behaves as if there were only a single measuring range.

In one example, the information about the thin layer is transferred to the measurement result of the thick layer. For example, if it is a measurement object with interfaces H, J and K, where the distance between H and J is large, but the distance between J and K is comparatively small. Thus, the low-resolution spectrum over the entire wavelength range provides a value for the layer thickness J-K, but not for the layer thicknesses H-J and H-K. The high-resolution spectrum over the partial range, on the other hand, shows the interferences H-J and H-K, but cannot distinguish between them or resolve them separately. An average value is output. The information about the layer thickness J-K can now be used to specify H-J and H-K separately by calculating back the mean value.

### BRIEF DESCRIPTION OF THE DRAWINGS

Further features and advantages of the disclosure are apparent from the following description of the embodiments with reference to the drawings. In the drawings:

FIG. 1 shows a measuring device according to the disclosure;

FIG. 2 shows an optical spectrometer of a measuring device according to the disclosure;

FIG. 3 shows another optical spectrometer;

FIGS. 4 and 5 show possibilities for coupling into the spectrometer;

FIG. 6 shows an exemplary measuring device comprising a reference arm;

FIGS. 7 and 8 show exemplary spectra;

FIG. 9 shows a processing of detector pixels.

### DESCRIPTION OF EMBODIMENTS

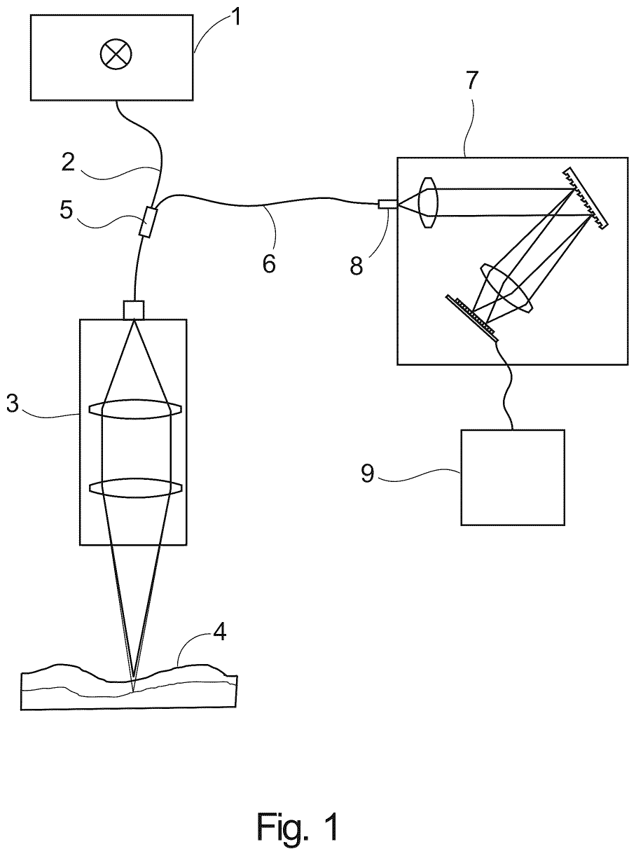

FIG. 1 shows a measuring device according to the disclosure. This comprises a light source 1 which emits measuring light of a continuous wavelength band. Advantageously, this is light in the visible or near-infrared range, e.g. light of the wavelengths 960 nm-1090 nm or 1250 nm-1370 nm. The light source is a known light generating means, e.g. LED, SLD or similar.

The measuring light is then guided by means of a first optical fiber 2 to a measuring head 3, which images the measuring light onto a measurement object 4. One or more boundary surfaces of the measurement object 4 reflect the measuring light and at least part of the reflected light is received again by the measurement head 3.

The returning measuring light is guided into another fiber 6, which is coupled to the first fiber 2 via a fiber coupler 5, for example. The measuring light is then fed via the other fiber 6 into the optical input 8 of the spectrometer 7, where a spectrum of the intensity over the wavelength is recorded. This spectrum is passed to an evaluation device 9, which calculates a thickness value from the spectral data. Details of the spectrometer 7 are shown in the following figures.

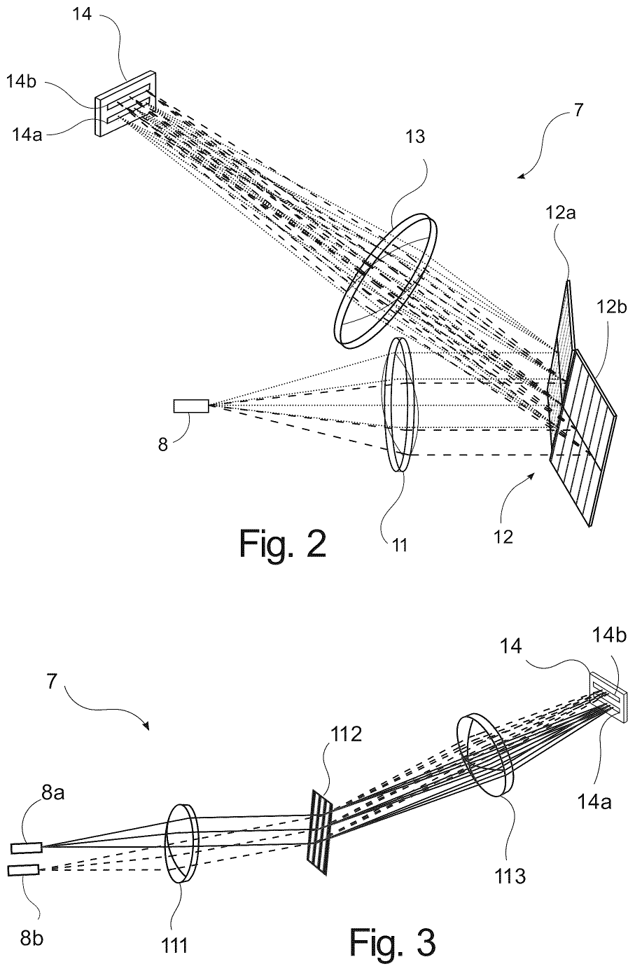

FIG. 2 shows an optical spectrometer of a measuring device according to the disclosure.

The spectrometer 7 shown in FIG. 2 is used as an optical spectrometer in a device as shown in FIG. 1.

Imaging optics are simplified here by individual lenses, but can in any case consist of several optical components, such as lenses and mirrors.

The spectrometer 7 has an optical input 8 through which the measuring light enters. The measuring light is then collimated by a first optical system 11 and strikes a grating element 12, consisting of two diffraction gratings: partial grating 12a and partial grating 12b. A spatial area of the collimated light beam falls on each of the partial gratings.

Reflection grating are shown here, but versions with transmission gratings are also included. The partial gratings 12a and 12b are designed in such a way that they cause different dispersion of the light. This variant of the disclosure allows a very free choice of the two spectral ranges, since these are determined by the two diffraction gratings used. In this embodiment shown, the two partial gratings are diffraction gratings with the same number of lines (e.g. 300 lines/mm), but which are arranged at different angles or orientations.

The light reflected by the grating element 12 is imaged onto a detector 14 via focusing optics 13. The detector 14 comprises at least two detector lines 14a and 14b, each consisting of a series of photosensitive pixels that can convert an incident light intensity into an electrical signal. The detector can also be an area detector (matrix detector), of which at least two lines are used.

While the principle is described here for two detector lines, a corresponding implementation with three or more lines is also covered by the disclosure.

The light reflected by partial grating 12a is shown here as solid lines. The partial grating 12a is arranged in space and tilted in such a way that light of a specific diffraction order, for example the second diffraction order, is imaged onto the first detector line 14a. The number of lines of the partial grating 12a and the imaging properties of the focusing optics 13 are selected so that the entire wavelength range of the measured light is imaged spread out over the length of the detector line 14a.

The light reflected by partial grating 12b is shown here in dashed lines. The partial grating 12b is arranged in space and tilted in such a way that light of a higher diffraction order than that used with partial grating 12a is imaged onto the second detector line 14b. For example, this is the fourth diffraction order. Conveniently, the partial grating 12b is not only tilted in the spatial direction of the splitting (transverse to the lines) with respect to partial grating 12a, but also tilted in the spatial direction along the lines, so that the light hits the other detector line. The number of lines of the partial grating 12b and the imaging properties of the focusing optics 13 are selected so that only a section of the wavelength range of the measuring light is imaged fanned out over the length of the detector line 14b. This section may comprise less than half of the entire wavelength range.

In an example, in order to simplify the implementation of the device, partial gratings 12a and 12b have the same number of lines and differ only in their orientation. Alternatively, however, the number of lines can also differ, whereby the spatial tilt in the direction of the splitting of the partial gratings relative to one another can be selected to be smaller or zero.

It is advantageous if the partial gratings 12a and 12b are arranged in the beam in such a way that approximately the same total intensity is directed onto both detector lines 14a and 14b. In particular, this means that the boundary between the partial gratings 12a and 12b is not in the middle of the beam, but offset, so that more light falls on partial grating 12b.

In an exemplary embodiment of the disclosure, the section of the wavelength range is approximately in the middle of the total wavelength range, and/or it is the section in which the light source 1 provides the most intensity.

For example, the total wavelength range emitted and utilized by the light source comprises near-infrared light from 960-1090 nm, the section comprises 1055-1090 nm. As an alternative example, the total wavelength range emitted and utilized by the light source comprises near-infrared light from 1250-1370 nm, the section comprises 1290-1320 nm. These wavelength ranges are particularly useful for measuring silicon or similar materials that are transparent in the near-infrared range. The use of wavelength bands in the visible range should also be considered for some applications.

For example, the entire wavelength range is fanned out over at least approximately the entire length of the first detector line 14a, while only a section of the wavelength range is fanned out over the same length of the second detector line. Since both detector lines comprise the same number of detector pixels, this means that the spectrum created from the data of the second detector line 14b has a higher resolution per wavelength unit than the spectrum from the data of the first detector line 14a, with both lines outputting the same number of data points.

The data from both detector lines is then forwarded to the evaluation unit. Both spectra are analyzed by means of the evaluation device. In particular, each spectrum is rectified and Fourier-transformed in a known manner, whereby frequencies of the modulation can be identified which correspond to certain path length differences between reflecting surfaces. As explained above, for larger path length differences (closer to the upper measurement range limit of the device), the spectrum from detector line 14a data no longer resolves the modulation well, as the modulations are narrower than the spacing of the data points. The spectrum from data from detector line 14b, on the other hand, can be evaluated, as a narrower range of the wavelength band is used here and the data points are therefore closer together. The opposite is true for small path length differences (near the lower limit of the measuring range), where the data from detector line 14a is easier to use. In this case, the spectrum from the data of detector line 14b does not show sufficient modulations.

From both spectra, recognizable optical thicknesses or path length differences between two surfaces are detected. The surfaces can be several boundary surfaces of the measurement object or a boundary surface of the measurement object and a reference surface within the measurement device.

The thickness values obtained are then compared to identify matches in the range in which both spectra provide usable results. A consolidated list of thickness values is then output to the user. Optionally, a graphical overlay of both spectra or both Fourier-transformed spectra can be output for visualization.

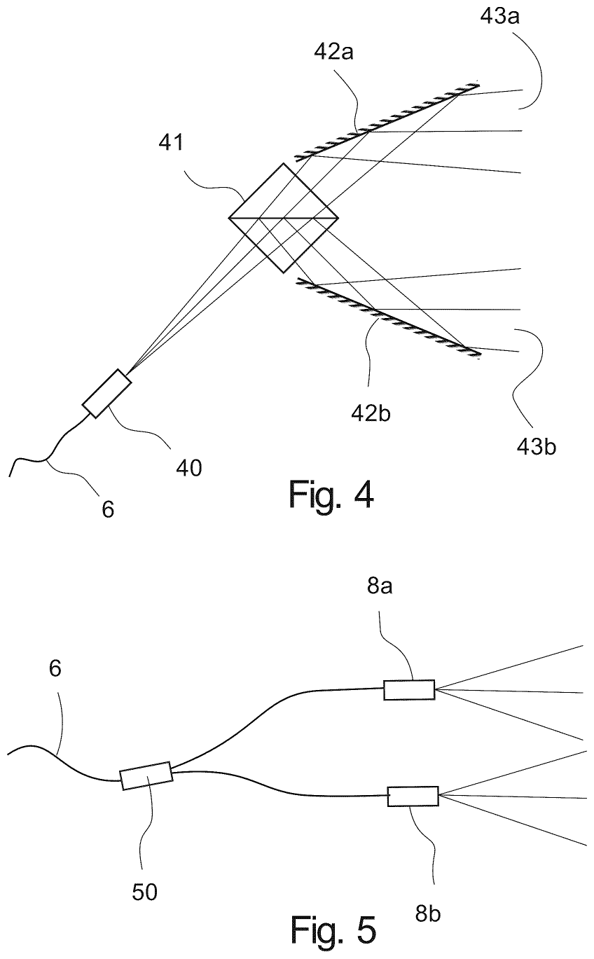

FIG. 3 shows another exemplary optical spectrometer.

As an alternative to the approach with two different partial diffraction gratings, shown in FIG. 2, a single diffraction grating can also be used, shown here in FIG. 3. In this case, the diffracted measuring light from two different diffraction orders would be mapped from one grating onto the respective detector lines. In order to realize the spatial offset of the two spectra, the input light must be coupled into the spectrometer via two points in space. In this variant, the two spectral ranges are not as freely selectable as in the previously mentioned variant.

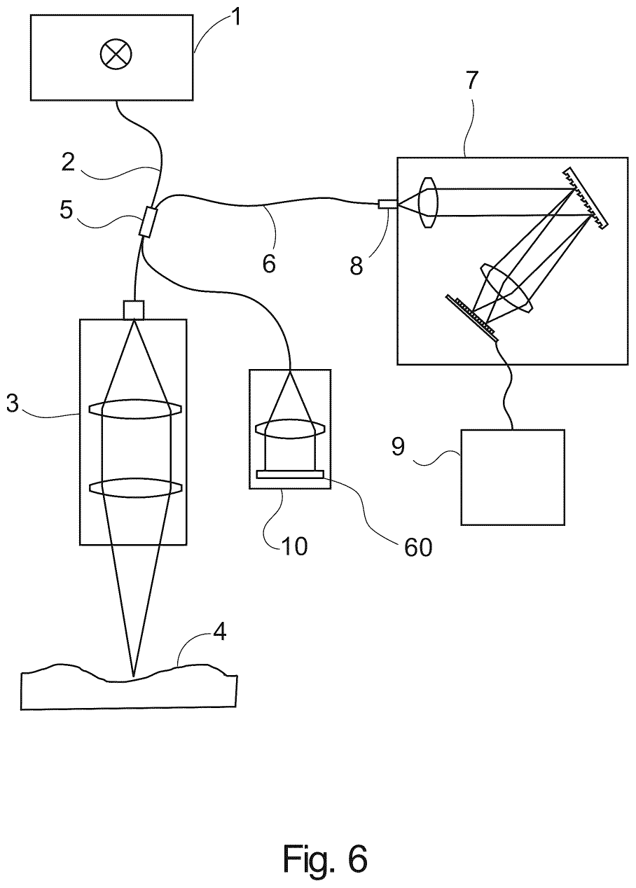

In this embodiment, the light is coupled into the spectrometer through two spatially spaced inputs 8a and 8b. The implementation of the two inputs is explained further below in FIG. 4. Light from both inputs 8a and 8b is collimated by an optical system 111, which may consist of several optical elements, and directed onto an optical diffraction grating 112. Diffracted light is then imaged onto a detector 14 by focusing optics 113, which may consist of several optical elements. This detector corresponds in its design to the detector described in connection with FIG. 2 and comprises at least two detector lines 14a and 14b or a matrix detector, of which two lines are used. The diffraction grating shown here is a transmission grating, but in principle reflection gratings are also included.

The input 8a is arranged spatially to the grating 112 and detector 14 in such a way that light of a certain diffraction order of the grating, for example the 3rd diffraction order, is imaged onto the detector line 14a. The elements of the spectrometer are selected and arranged in such a way that essentially the entire wavelength range of the measured light is imaged fanned out over the length of the detector line 14a.

The second input 8b, on the other hand, is arranged at a distance from input 8a in such a way that a higher diffraction order of the grating, for example the 4th diffraction order, is imaged on the detector line 14b. Due to the higher diffraction order, the light is more spread out, which is why only a section of the entire wavelength band is imaged over the length of the detector line.

In an example, the inputs 8a and 8b are offset both in the spatial direction parallel to the grating lines (to effect mapping to the two different detector lines 14a and 14b) and offset in the spatial direction transverse to the grating lines and the optical axis (to meet the different diffraction orders).

The resulting incidence of light on the detector lines then corresponds in principle to that described in FIG. 2. Further processing and evaluation are carried out as described there.

While the principle is described here for two detector lines, an implementation with three or more lines is also covered by the disclosure.

By appropriately selecting the diffraction orders, the grating tilt angle and the distance between the two inputs, it is therefore possible to ensure that the two partial spectra have the same width in the detector plane and lie on top of each other

A further embodiment of the disclosure is a hybrid solution between the embodiment of FIG. 2 and the embodiment of FIG. 3, in which there are two partial gratings with different orientations or properties as well as two spaced light inputs. Light from each input is fanned out by means of a different (in number of lines and/or orientation) partial grating and directed onto one detector line each.

FIGS. 4 and 5 show possibilities for coupling into the spectrometer 7 of FIG. 3.

FIG. 4 shows a free beam solution. Light coming from the measuring head via fiber 6 exits a fiber end 40 and is split into two partial beams by a beam splitter 41, shown here as a beam splitter cube. The beam splitter cube can split 50/50, or in any other ratio, for example so that the total intensity on each of the detector lines 14a and 14b is the same, as explained for FIG. 2. The beams are then deflected by deflecting mirrors 42a and 42b so that the center beams are parallel. The light is then further processed as described for FIG. 3, wherein the positions of the inputs 8a and 8b correspond to the virtual source points behind the deflecting mirrors 42a and 42b.

FIG. 5 shows an implementation as fiber optics. The fiber 6 coming from the sensor head is connected by a fiber coupler 50 to two other fibers, to which the light is split. Here too, a suitable splitting ratio can be selected as described above. The light then emerges from the fiber ends, which correspond to the spectrometer inputs 8a and 8b.

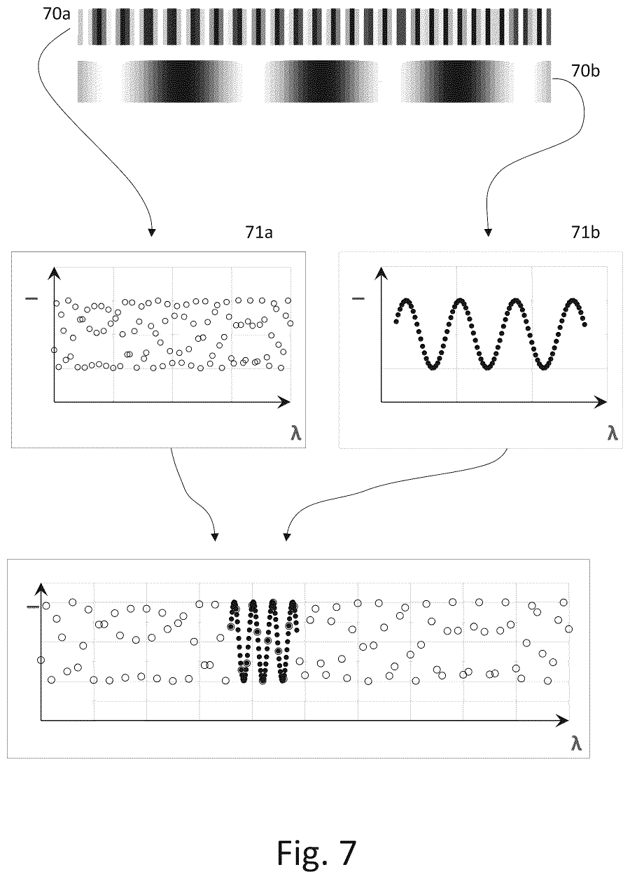

FIG. 6 shows an exemplary measuring device with a reference arm. FIG. 6 corresponds to the device shown in FIG. 1, with an additional reference arm 10 connected to the fiber coupler 5. A portion of the light from the light source 1 is directed into the reference arm 10 instead of into the measuring head 3, where it is reflected at a reference surface 60 and guided from there the same way back to the fiber coupler 5. There, the light from the reference arm is combined with the light from the measuring head 3 and guided into the fiber 6 in the direction of the spectrometer 7. Alternatively, a version with a reference arm is also provided, which conducts all or part of the light as a free beam instead of via fibers. In particular, a beam splitter is then used instead of the fiber coupler.

The use of a reference arm 10 makes it possible to measure a height position on a measurement object relative to a fixed reference point. If the location of the measurement on the measurement object is scanned, topographies can be created.

Mixed measurement configurations are also possible, in which both one or more layer thicknesses of the measurement object are measured (by interference between light reflected at different boundary surfaces of the measurement object) and a topography of the measurement object relative to a fixed point by means of the reference arm. A switchable reference arm is also possible.

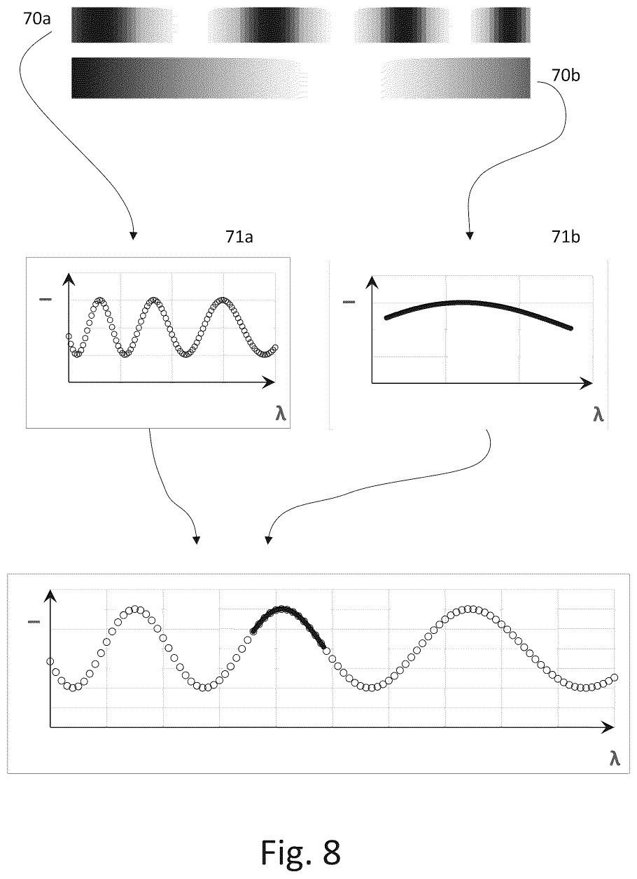

FIG. 7 shows exemplary spectra with a large path length difference.

The intensity signal on detector line 14 a is shown here graphically as 70a. A spectrum 71a is generated from this. Accordingly, the intensity signal on detector line 14b is shown as 70b and the corresponding spectrum as 71b. As can be seen here, the modulations caused by the interference are so narrow that they cannot be resolved by spectrum 71a, but can be resolved by 71b.

FIG. 8 shows exemplary spectra with a small path length difference.

The detector signals and spectra correspond to FIG. 7, wherein here the modulation can be better resolved by spectrum 71a.

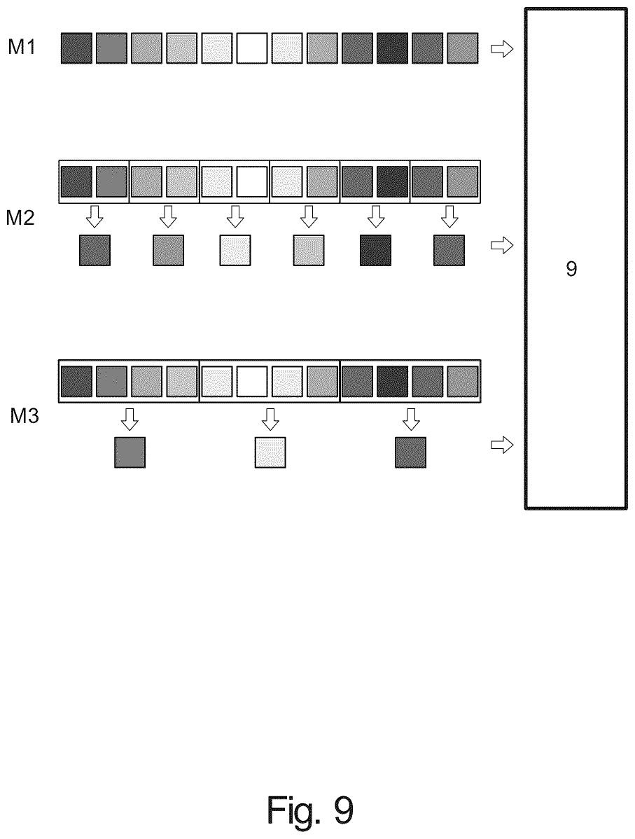

FIG. 9 schematically shows the processing of detector pixels in another optical measuring device.

As an alternative to physically fanning out the measured light differently in the spectrometer, as shown in the previous figures, the resolution or the number of data points of the spectrum can also be set electronically. This enables the use of a single detector line, which can be switched over. However, it is also possible to use two detector lines that provide different resolutions at the same time.

The basis is the so-called “pixel binning”, which makes it possible to read out several neighboring pixels of a detector line in groups.

A line detector is used, which offers the option of reading out pixels together by binning. For example, with a detector that actually has 2048 pixels, only 1024 pixels can be used for further and faster processing (two pixels binned together in each case). At the same time, it should be possible to read out 2048 unbinned pixels from the detector, but only use half of them for the same fast further processing. It is also possible to read out only some of the pixels, e.g. pixels 512 to 1536. Advantageously, a section of the line is read out. This results in two readout options that are fast in downstream processing and, above all, can run in the same way.

The device can switch between small and large measuring ranges during operation by pixel binning without having to change the signal processing in the device. This also makes it possible to create a device with a large measuring range if computer resources are limited.

The full spectral range is mapped onto the detector over the entire line length. The spot size of the optical image on the detector should be smaller than or equal to the pixel size of the detector (unbinned pixel size).

By binning or ignoring half of the pixels, two spectral ranges and thus two measuring ranges can be evaluated with otherwise the same optical setup (also the same light source) and further processing using software.

The full spectral range of a light source is mapped onto a detector line. In a first mode, all pixels are read out separately, but half of the pixels are not used. The unused pixels must lie next to each other, i.e. form a geometric block. This means that a small spectral range is effectively read out. This makes it possible to measure large path length differences. In a second mode, neighboring pixels are read out in pairs. Due to the full spectral range, a small path length difference can be measured in interferometric devices. Both modes can be used without having to change the further processing in the controller.

It is advantageous to switch between the modes depending on the nature of the measured object. It is also possible to switch quickly back and forth between the modes in order to measure different path length differences virtually simultaneously.

The first mode is shown schematically in FIG. 9 as M1: all pixels of the detector line are read out and transmitted to the evaluation unit 9. The second mode is shown as M2: here the pixels are read out in pairs and the sum or average values of each pair are transmitted to the evaluation unit 9. An alternative second mode is shown as M3: instead of being read out in pairs, the pixels are read out in groups of 4. A generalization to groups of N pixels is possible.

The above example can also take place on two lines (again only one light source, one spectrometer, but the spectrum is split over two or more lines, as described above, but with equal fanning on both lines. Modes 1 and 2 can thus be used separately and, if necessary, in parallel.

Other alternative solutions, which are not shown in the figures, can also be considered:

An implementation in which the detector only comprises one line, but the focal length of the optics is variable. Consequently, the spectral width that is imaged on the detector could be varied. This solution is more complex in terms of design and does not allow both spectral ranges/resolutions to be captured at the same time, but it manages with fewer detector lines.

It is also possible to use only one grating, but one that is adjustable in angle so that it is possible to switch between different grating orders. A solution based on the principle of FIG. 3 is also possible, but with switching between the inputs, e.g. via a fiber switch.

What is claimed is:

1-14. (canceled)

15. An optical interferometric measuring device, the measuring device comprising:
a light source that is configured to generate measuring light having a continuous wavelength range;
a measuring head that is optically connected to the light source, directs the measuring light onto a measurement object and receives measuring light reflected from the measurement object;
an evaluation device; and
an optical spectrometer, wherein the optical spectrmeter
i) is configured to output a first spectrum to the evaluation device, wherein the first spectrum results from an interference between a first portion of the measuring light, which was reflected by a first boundary surface of the measurement object, and a second portion of the measuring light, which was reflected by at least one second boundary surface of the measurement object or by a reference boundary surface,
ii) includes at least one grating configured to fan out the measured light guided into the spectrometer according to wavelengths, and
iii) includes a first detector line, to which fanned measuring light is directed and which comprises a plurality of detector pixels, and
wherein
the first spectrum includes a series of intensity values measured by the detector pixels of the first detector line,
the evaluation device is configured to calculate, based on the first spectrum, an optical path difference between the first boundary surface on the one hand and the second boundary surface or the reference surface on the other hand,
the optical spectrometer includes at least one second detector line, to which fanned measuring light is directed and which comprises a plurality of detector pixels,
a second spectrum includes a series of intensity values measured by the detector pixels of the second detector line,
the first spectrum covers at least substantially the entire continuous wavelength range with a first resolution, and
the second spectrum covers a section of the continuous wavelength range in a second resolution that is higher than the first resolution.

16. The measuring device of claim 15, wherein the grating element comprises a first partial grating and a second partial grating, wherein the first partial grating is configured to direct measuring light of the entire continuous wavelength range fanned out over a length of the first detector line, and wherein the second partial grating is configured to direct a section of the continuous wavelength range further fanned out over a length of the second detector line.

17. The measuring device of claim 16, wherein the first partial grating and the second partial grating are formed by spatially separated areas of the grating element, on which different parts of the measuring light impinge.

18. The measuring device of claim 16, wherein the first partial grating and the second partial grating have the same line number, but are oriented at different solid angles.

19. The measuring device of claim 16, wherein the first partial grating and the second partial grating have different line numbers.

20. The measuring device of claim 15, wherein the spectrometer has a single optical input for the measuring light.

21. The measuring device of claim 15, wherein the spectrometer has at least two spatially spaced optical inputs for the measuring light.

22. The measuring device of claim 21, wherein the optical inputs are configured such that light having identical properties enters through each of the optical inputs.

23. The measuring device of claim 15, wherein the measuring light is directed to the detector lines in such a way that the sum of the intensity values over the first detector line and the sum of the intensity values over the second detector line are approximately equal, in particular equal when there is no interference modulation.

24. The measuring device of claim 15, further comprising a reference arm that includes the reference surface.

25. The measuring device of claim 15, wherein the spectrometer and the evaluation device are configured to read out all pixels of the first detector line individually and to read out the pixels of the second detector line paired or averaged in groups of N pixels.

26. A method for optical interferometric measurement, the method comprising:
directing measuring light having a continuous wavelength range onto a measurement object by a measuring head;
feeding measuring light, which was reflected from the measured object via the measuring head, into a spectrometer;
outputting a first spectrum, which results from an interference between a first portion of the measuring light, which was reflected by a first boundary surface of the measurement object, and a second portion of the measuring light, which was reflected by at least one second boundary surface of the measurement object or by a reference boundary surface, wherein the first spectrum includes a discrete data series of intensity values over wavelengths;
outputting a second spectrum, which results from the interference between the first and second portions of the measuring light, wherein the second spectrum includes a second discrete data series of intensity values over wavelengths, and wherein a number of data points per wavelength unit is greater for the second spectrum than for the first spectrum; and
calculating an optical path length differences from the first spectrum and from the second spectrum using an evaluation unit based on a modulation of the first spectrum and on a modulation of the second spectrum.

27. The method of claim 26, wherein the first spectrum covers a larger wavelength range than the second spectrum.

28. The method of claim 27, wherein a total number of data points in the first spectrum and in the second spectrum are the same.

29. The method of claim 26, wherein a path length difference calculated based on the modulation of the first spectrum and a path length difference calculated based on the modulation of the second spectrum are consolidated and output collectively.
